(19) United States
(12) Patent Application Publication
(10) Pub. No.: US 2026/0174209 A1
(43) Pub. Date: Jun. 25, 2026

(54) REMOTE-CONTROLLED ELECTRONIC DEVICE

(71) Applicants: Zhongyuan GUO, Tianjin (CN); Huiquan CHEN, Zhuhai (CN)

(72) Inventor: Huiquan CHEN, Zhuhai (CN)

(21) Appl. No.: 19/540,686

(22) Filed: Feb. 14, 2026

(30) Foreign Application Priority Data
Dec. 10, 2025 (CN) 202522623276.1

(51) Int. Cl. A45D 20/12

(52) U.S. Cl. CPC A45D 20/12; A61H 2201/0149

(57) ABSTRACT

A remote-controlled electronic device includes an electronic device terminal and a remote control unit. The electronic device terminal includes an execution unit, a processor, and a wireless signal receiving module. The execution unit and the wireless signal receiving module are connected to the processor. The remote control unit includes a pressure sensor and a wireless signal transmitting module. The pressure sensor is connected to the wireless signal transmitting module. The wireless signal transmitting module is in signal communication with the wireless signal receiving module. The wireless signal transmitting module is configured for transmitting pressure information detected in real time by the pressure sensor to the wireless signal receiving module, so as to adjust a real-time operating frequency or power of the execution unit.

### CROSS-REFERENCE TO RELATED APPLICATIONS

The application claims priority of Chinese patent application CN 2025226232761, filed on Dec. 10, 2025, disclosure of which is incorporated herein by reference in its entirety.

### TECHNICAL FIELD

The present disclosure relates to the field of electronic devices and remote control technology, in particular to a remote-controlled electronic device.

### BACKGROUND

Currently, in existing remote-controlled electronic devices on the market, such as remote-controlled toy cars and massage devices, the remote controllers can only set the products to operate at a single and predetermined frequency or power level. For example, remote-controlled toy cars can only maintain a single driving speed. Further, even with a remote controller featuring multiple operating gears, some massage devices can only maintain a single vibration frequency once a specific gear is selected. Moreover, switching between different frequencies requires users to precisely and individually actuate the corresponding gear buttons. This operation is cumbersome and inconvenient, making it particularly difficult for users to perform under special conditions such as nervousness or when enduring discomfort.

### SUMMARY

To solve the above problems in the existing technology, the present disclosure provides a remote-controlled electronic device.

To solve the above technical problems, the present disclosure adopts the following technical solution.

The remote-controlled electronic device provided by the present disclosure includes an electronic device terminal. The electronic device terminal comprises an execution unit, a processor, and a wireless signal receiving module. The execution unit and the wireless signal receiving module are connected to the processor.

The remote-controlled electronic device further includes a remote control unit. The remote control unit includes a pressure sensor and a wireless signal transmitting module. The pressure sensor is connected to the wireless signal transmitting module.

The wireless signal transmitting module is in signal communication with the wireless signal receiving module. The wireless signal transmitting module is configured for transmitting pressure information detected in real time by the pressure sensor to the wireless signal receiving module, so as to adjust a real-time operating frequency or power of the execution unit.

Beneficial effects of the present disclosure are as follows. The present disclosure utilizes a pressure sensor to detect the user’s grip pressure on the remote control unit in real time. Based on this pressure information, the operating frequency or power of the execution unit can be adjusted in real time. This makes the adjustment control simple and intuitive, thereby allowing the adjustment operation to be easily performed when the user is in emotional states such as tension, endurance, or excitement. Consequently, the remote-control performance and user experience of the electronic device are significantly enhanced.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a structural schematic block diagram of the remote-controlled electronic device of the present disclosure;

FIG. 2 is a cross-sectional view of a vibrator of the remote-controlled electronic device in the embodiment of the present disclosure;

FIG. 3 is a cross-sectional view of a handheld remote controller of the remote-controlled electronic device in the embodiment of the present disclosure;

FIG. 4 is a structural diagram of a neck massage device in the embodiment of the present disclosure;

FIG. 5 is a structural diagram of a facial massage device in the embodiment of the present disclosure;

FIG. 6 is a structural diagram of a waist massage device in the embodiment of the present disclosure;

FIG. 7 is a structural diagram of an eye massage device in the embodiment of the present disclosure;

FIG. 8 is a structural diagram of a toy car in the embodiment of the present disclosure;

FIG. 9 is a structural diagram of a hair dryer in the embodiment of the present disclosure;

FIG. 10 is a structural diagram of a fan in the embodiment of the present disclosure.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

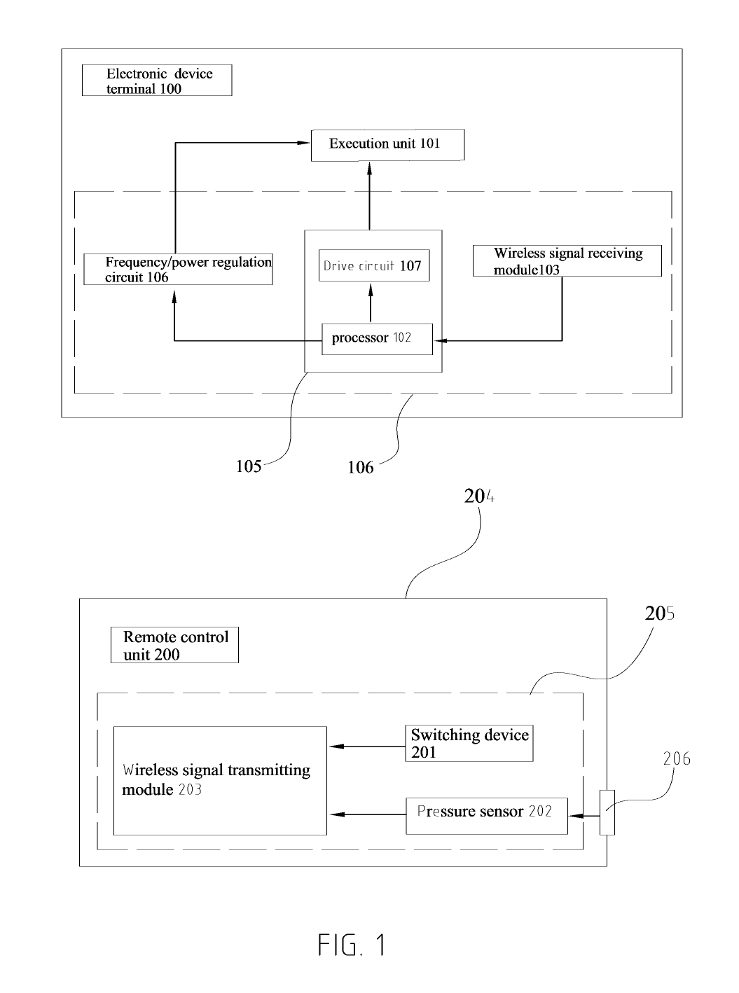

Referring to FIG. 1, the present disclosure provides a remote-controlled electronic device. The remote-controlled electronic device includes an electronic device terminal 100 and a remote control unit 200. The electronic device terminal 200 includes an execution unit 101, a processor 102, and a wireless signal receiving module 103. The execution unit 101 and the wireless signal receiving module 103 are connected to the processor 102. The processor 102 is a Microcontroller Unit (MCU) configured for controlling the execution unit 101. The wireless signal receiving module 103 is in wireless communication with the remote control unit 200. Specifically, the electronic device terminal 100 includes a first circuit board 104. The processor 102 and the wireless signal receiving module 103 are integrated on the first circuit board 104. The execution unit 101 is connected to the first circuit board 104. More specifically, an execution unit control circuit 105 and a frequency/power regulation circuit 106 are integrated on the first circuit board 104. The execution unit control circuit 105 includes the processor 102 and a drive circuit 107.

The remote control unit 200 includes a pressure sensor 202 and a wireless signal transmitting module 203. Preferably, the remote control unit 200 further includes a switching device 201. The switching device 201 and the pressure sensor 202 are connected to the wireless signal transmitting module 203. Specifically, the remote control unit 200 includes a second circuit board 205. The switching device 201, the pressure sensor 202, and the wireless signal transmitting module 203 are integrated on the second circuit board 205. The switching device 201 is configured for generating a start or a stop command signal to control the execution unit 101. The pressure sensor 202 is configured for detecting the real-time pressure information from a user’s grip on the remote control unit 200. The wireless signal transmitting module 203 is in signal communication with the wireless signal receiving module 103. The wireless signal transmitting module 203 is configured for transmitting the real-time pressure information detected by the pressure sensor 202 to the electronic device terminal 100.

It should be noted that the execution unit 101, the processor 102, the wireless signal receiving module 103, the frequency/power regulation circuit 106, the drive circuit 107, the switching device 201, the pressure sensor 202, and the wireless signal transmitting module 203 are all existing technologies, and their structures and operating principles will not be elaborated here.

The operating procedures of the remote-controlled electronic device are as follows. First, the switching device 201 of the remote control unit 200 is operated to transmit a start command signal to the electronic device terminal 100 via the wireless signal transmitting module 203. Then, the electronic device terminal 100 is configured for receiving the start command signal via the wireless signal receiving module 103 and transmitting this signal to the processor 102. The processor 102 is configured to activate the execution unit 101 based on the start command signal. Afterwards, the pressure sensor 202 is configured for detecting the real-time pressure information and transmitting it to the wireless signal receiving module 103 via the wireless signal transmitting module 203. The processor 102 is configured to subsequently adjust the real-time operating frequency or power of the execution unit 101 based on the real-time pressure information. Specifically, the processor 102 is configured to gradually adjust the real-time operating frequency or power of the execution unit 101 according to the increasing real-time pressure. When the real-time pressure gradually decreases, the processor 102 is configured to gradually reduce the real-time operating frequency or power of the execution unit 101. After use, the switching device 201 of the remote control unit 200 is configured for issuing a stop command signal, so that the execution unit 101 can be controlled to stop operation.

The remote-controlled electronic device of the present disclosure utilizes the pressure sensor 202 to detect the user’s grip pressure on the remote control unit 200. Based on this pressure information, the operating frequency or power of the execution unit 101 is adjusted in real time. This makes the adjustment control simple and intuitive. Particularly, under emotional states such as (extreme) tension, endurance, or excitement, where precise manual operation is difficult to perform, the user can effortlessly perform adjustment operations. Consequently, the remote control performance and user experience of the electronic device are significantly enhanced.

Preferably, the remote control unit 200 includes a housing 204, the switching device 201, the pressure sensor 202, and the wireless signal transmitting module 203 are arranged inside the housing 204. The housing 204 is at least provided with a deformable elastic portion 206 positioned opposite the pressure sensor 202, so as to trigger the pressure sensor 202 upon deformation. The housing 204 is preferably made of silicone. In this way, the deformable and elastic housing, or the deformable elastic portion 206 arranged on the housing, ensures the sensitivity of the pressure sensor 202 in real-time detection of the pressure information. This achieves high detection accuracy and enhances the stability of the control performance of the remote control unit 200 on the electronic device terminal 100.

The remote-controlled electronic device of the present disclosure will be further explained through the following embodiments.

### The first embodiment:

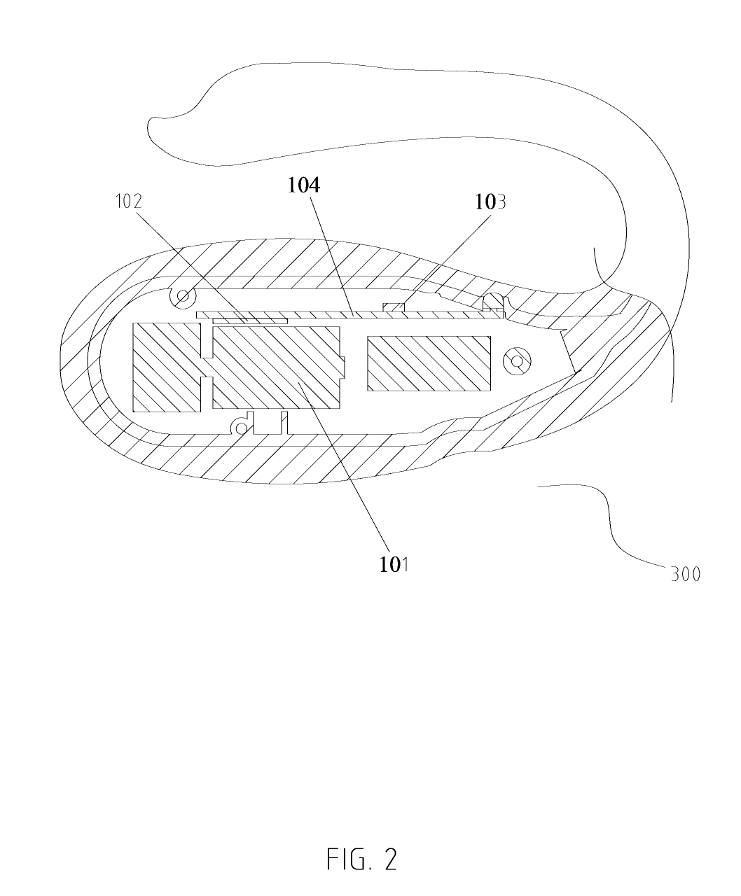

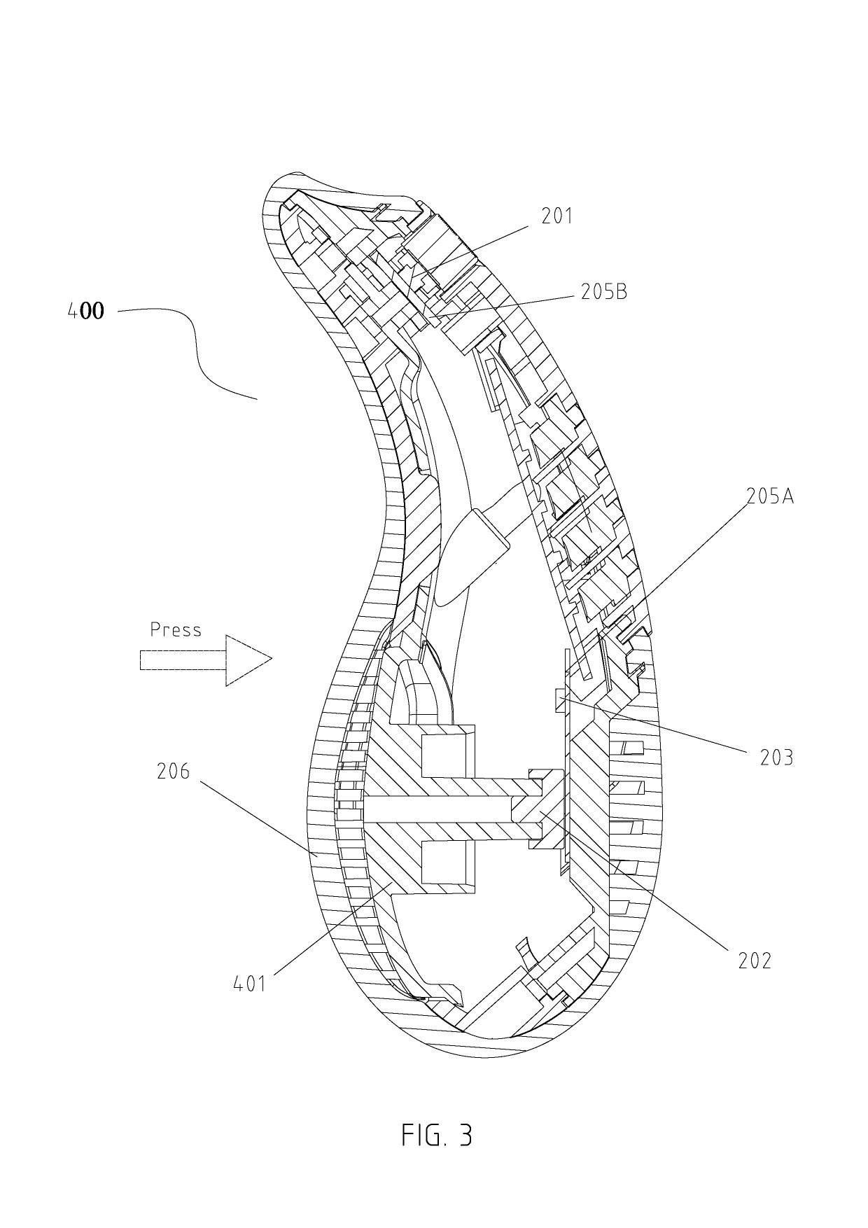

As shown in FIG. 2 and FIG. 3, the remote-controlled electronic device in the present embodiment is a remote-controlled vibration device, more specifically, a female private part muscle training and massage device. The remote-controlled vibration device includes a vibrator 300 (i.e., the electronic device terminal 100) and a handheld remote controller 400 (i.e., the remote control unit 200).

The vibrator 300 includes the first circuit board 104, the execution unit control circuit 105 (the processor 102 and drive circuit 107), the frequency/power regulation circuit 106, the execution unit 101, and the wireless signal receiving module 103 of the above-mentioned electronic device terminal 100. The execution unit 101 is a variable frequency motor, and the frequency/power regulation circuit 106 is a pulse width modulation circuit (i.e., PWM closed-loop control circuit). The frequency/power regulation circuit 106 is configured for adjusting the frequency of the variable frequency motor serving as the execution unit 101 according to the control instructions issued by the processor 102, thereby achieving vibration acceleration of the vibrator 300. The frequency/power regulation circuit 106 and the drive circuit 107 are not shown in the figures. Furthermore, the drive circuit 107 includes a relay control module and a motor current sampling module. The relay control module is configured to control the turning on and off of a relay, thereby controlling the startup and shutdown of the motor. The motor current sampling module is configured to collect and amplify a voltage signal, and provide the amplified signal to an Analog-to-Digital Converter sampling port of the MCU (the processor 102).

The handheld remote controller 400 includes the second circuit board 205, the switching device 201, the pressure sensor 202, and the wireless signal transmitting module 203 of the above-mentioned remote control unit 200. The second circuit board 205 consists of a main circuit board 205A and a subsidiary circuit board 205B. The main circuit board 205A and the subsidiary circuit board 205B are connected. The pressure sensor 202 and the wireless signal transmitting module 203 are integrated on the main circuit board 205A, and the switching device 201 is integrated on the subsidiary circuit board 205B. In addition, the housing 204 of the handheld remote controller 400 is provided with a deformable elastic portion 206. The deformable elastic portion 206 is connected to the pressure sensor 202 via a transmission member 401, preferably a silicone transmission member.

The remote-controlled vibration device of the present embodiment utilizes the pressure sensor 202 to detect the pressure applied by a female user when holding the remote control unit 200. This pressure information is used to adjust the real-time operating frequency of the variable frequency motor, thereby achieving vibration acceleration of the vibrator 300. This adjustment control is simple and intuitive. In particular, even when the user is in a state of enduring pain, the user can effortlessly perform the adjustment operation, thereby improving the effectiveness of muscle massage and training.

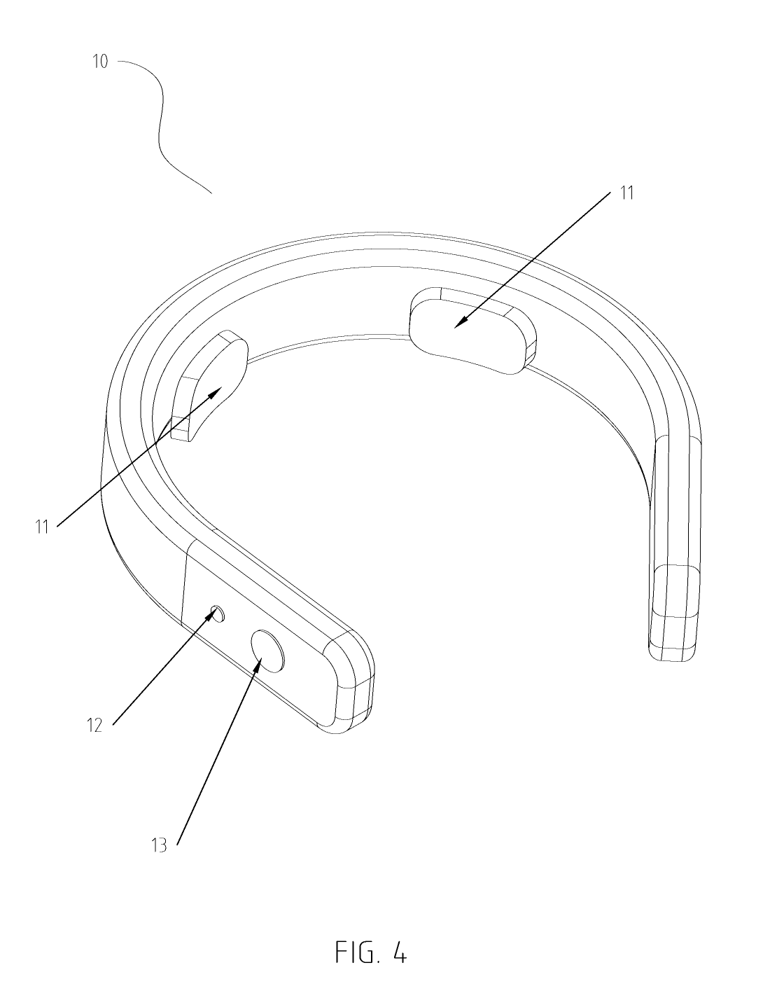

More specifically, the remote-controlled vibration device of the remote-controlled electronic device in the present embodiment may also be a neck massage device 10. As shown in FIG. 4, specifically, the neck massage device 10 is substantially identical in structure and function to the vibrator 300 of the above-mentioned embodiment. The neck massage device 10 and the vibrator 300 both include a first circuit board 104, an execution unit 101, and a PWM frequency adjustment circuit 106 controlled by the processor 102.

The remote control unit 200 is configured for detecting pressure information via the pressure sensor 202 and transmitting the pressure information to the processor 102. The processor 102 is configured to drive the execution unit 101 to accelerate via a PWM signal. Consequently, the variable frequency motor, which serves as the execution unit 101, is configured to drive a first massage portion 11 of the neck massage device 10 to generate high-frequency vibration, thereby achieving massage of the neck. The neck massage device 10 is further provided with a first indicator light 12 and a first control button 13. Both the first indicator light 12 and the first control button 13 are electrically connected to the processor 102. The first indicator light 12 is configured for indicating a state of the neck massage device 10, such as a power state or an operation mode. The first control button 13 is configured for adjusting and controlling an operating state of the neck massage device 10.

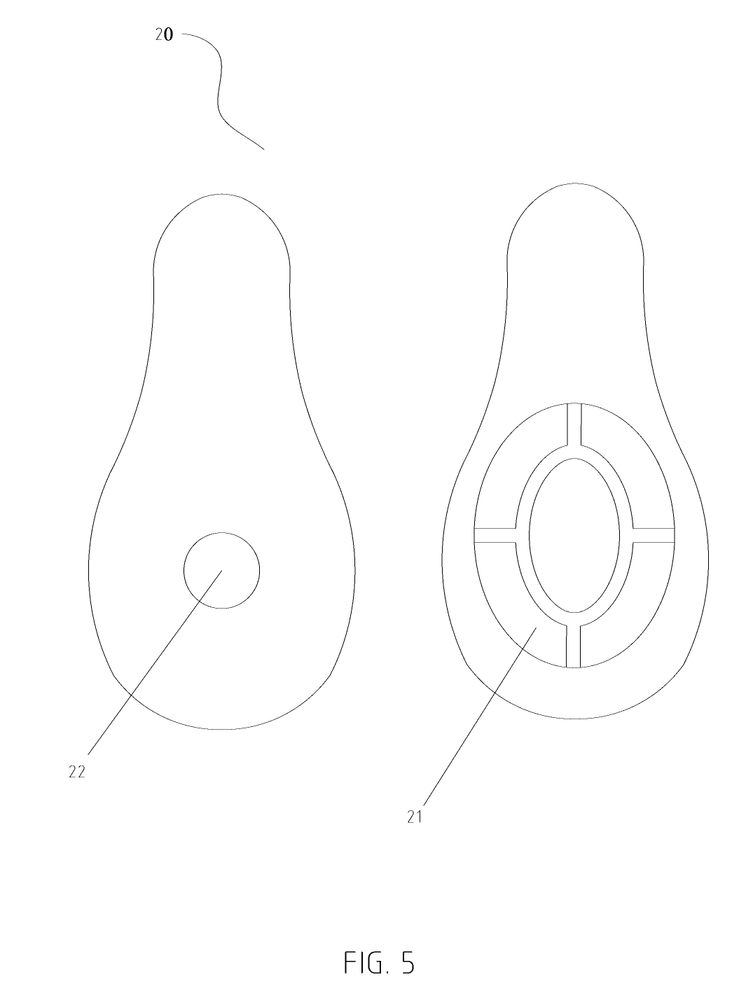

More specifically, the remote-controlled vibration device of the remote-controlled electronic device in the present embodiment may also be a facial massage device 20. As shown in FIG. 5, the facial massage device 20 is substantially identical to the vibrator 300 in the above-mentioned embodiment. A second massage portion 21 of the facial massage device 20 is driven by the variable frequency motor serving as the execution unit 101. In addition, the facial massage device 20 further includes an operation button 22 for controlling an operating state of the facial massage device 20.

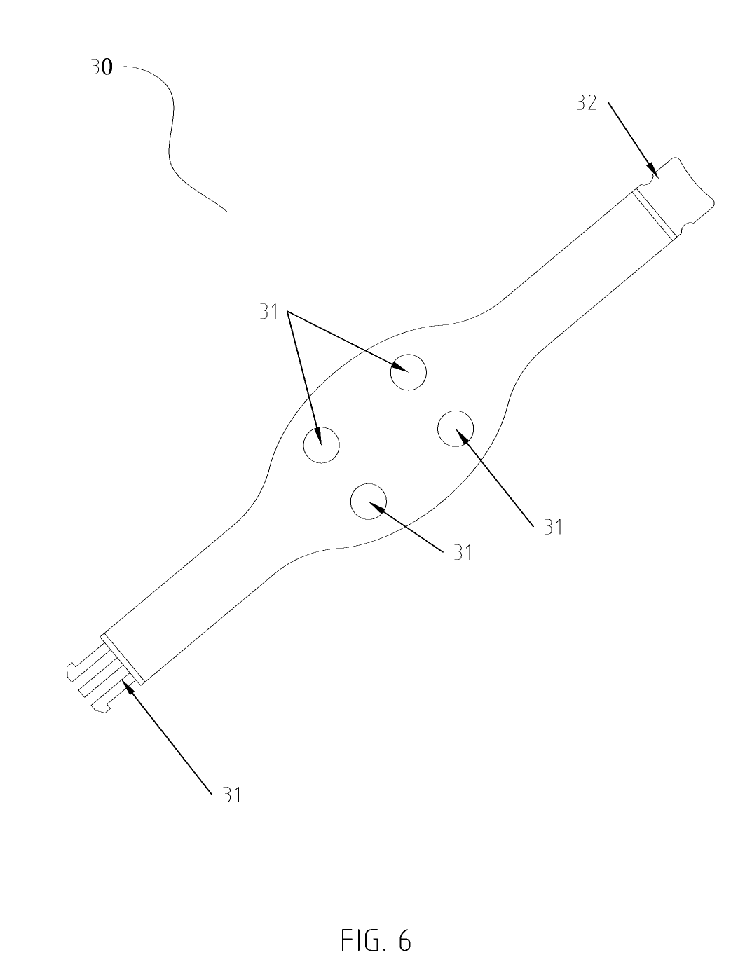

More specifically, the remote-controlled vibration device of the remote-controlled electronic device in the present embodiment may also be a waist massage device 30. As shown in FIG. 6, the waist massage device 30 is substantially identical in structure and function to the vibrator 300 of the above-mentioned embodiment. In addition, the waist massage device 30 is controlled in real time by the remote control unit 200. The output power of the variable frequency motor serving as the execution unit 101 is adjusted according to the pressure information from the pressure sensor 202. In this way, a third massage portion 31 of the waist massage device 30 is controlled to vibrate, thereby achieving deep vibration massage for waist muscles.

Both ends of the waist massage device 30 are respectively provided with a first connecting portion 32 and a second connecting portion 33. The first connecting portion 32 and the second connecting portion 33 are detachably connected, thereby making the massage device convenient to be worn on or removed from the waist of the human body. Specifically, the first connecting portion 32 is a male snap fastener, and the second connecting portion 33 is a female snap fastener. The male snap fastener and the female snap fastener are connected, so as to achieve quick connection and adjustment. Of course, the first connecting portion 32 may also be a female snap fastener, and the second connecting portion 33 may be a male snap fastener. In addition, the first connecting portion 32 and the second connecting portion 33 may also be detachably connected via other connection methods, such as being connected by hook and loop fasteners, which is not limited here.

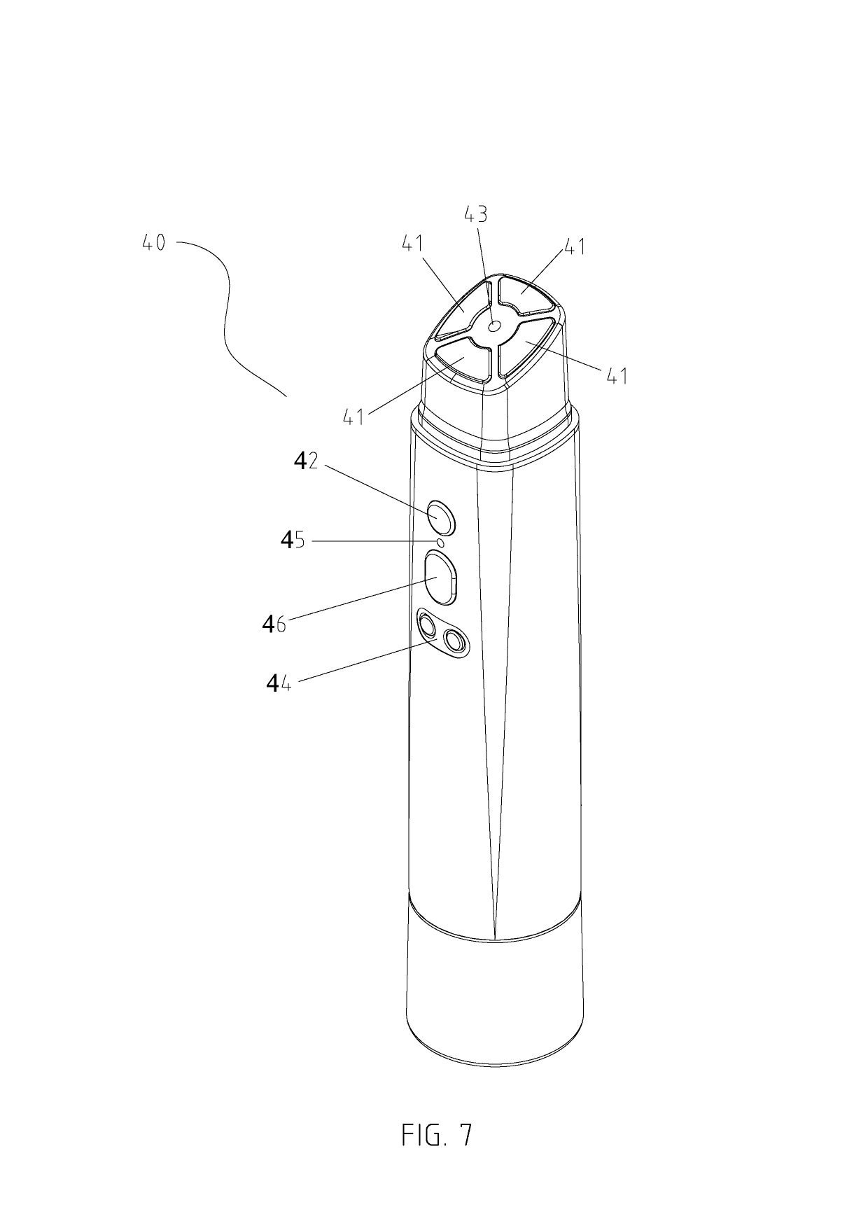

More specifically, the remote-controlled vibration device in the present embodiment may also be an eye massage device 40. As shown in FIG. 7, the eye massage device 40 is substantially identical in structure and function to the vibrator 300 described in the above embodiment. The execution unit 101 of the eye massage device 40 is controlled by the remote control unit 200. By adjusting the output power of the variable frequency motor serving as the execution unit 101, vibration of a fourth massage portion 41 of the eye massage device 40 is achieved, thereby achieving vibrational relaxation of acupoints around the eye.

Furthermore, a heating module is electrically connected to the first circuit board 104 of the eye massage device 40. The heating module is capable of providing heat application during massage, so as to enhance relaxation and soothing effects. The eye massage device 40 is provided with a first switch button 42, and the first switch button 42 is electrically connected to the first circuit board 104. The first switch button 42 is used to control the turning on or turning off of the eye massage device 40, as well as the start or stop of the heating function.

The eye massage device 40 of this embodiment is further provided with a liquid outlet channel 43. The liquid outlet channel 43 contains eye essence. The vibration frequency generated by the execution unit 101 drives the eye essence to be gradually released through the liquid outlet channel 43 to the fourth massage portion 41. Therefore, this achieves the infusion of the essence simultaneously with vibration and heat application, further enhancing the care effectiveness. The eye massage device 40 is further provided with a charging port 44 for charging. The charging port 44 is electrically connected to the first circuit board 104.

The eye massage device 40 is further provided with a third indicator light 45 and a third control button 46. Both the third indicator light 45 and the third control button 46 are electrically connected to the processor 102. The third indicator light 45 is configured for indicating a state of the eye massage device 40, such as a power state or an operating mode. The third control button 46 is configured for adjusting and controlling the operating state of the eye massage device 40.

### The second embodiment:

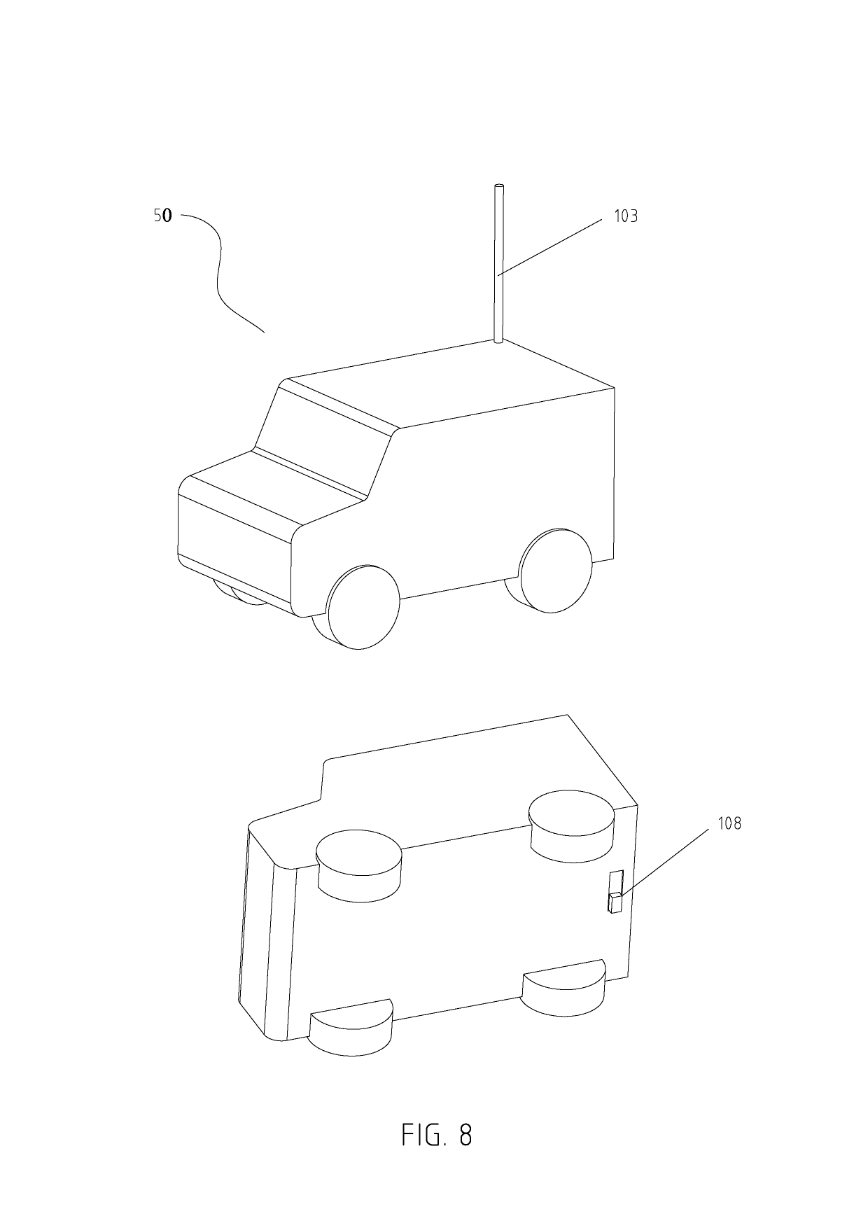

Of course, the remote-controlled electronic device of the present disclosure may also be a remote-controlled toy car, as shown in FIG. 8. The remote-controlled toy car includes a toy car 50 and a remote controller. The toy car includes the first circuit board 104, the execution unit control circuit 105 (the processor 102 and the drive circuit 107), the frequency/power regulation circuit 106, the execution unit 101, and the wireless signal receiving module 103 of the aforementioned electronic device terminal 100. The execution unit 101 is a variable frequency motor, and the frequency/power regulation circuit 106 is a pulse width modulation circuit (i.e., PWM closed-loop control circuit). The remote controller includes the second circuit board 205, the switching device 201, the pressure sensor 202, and the wireless signal transmitting module 203 of the aforementioned remote control unit 200. Preferably, the wireless signal receiving module 103 of the toy car is an antenna, and a second switch button 108 for controlling start and stop is provided at a bottom portion of the toy car 50.

### The third embodiment:

The remote-control electronic device of the present disclosure may also be a heating device or a light-emitting device. Correspondingly, the execution unit 101 may be a heating element or a light-emitting element, and the frequency/power regulation circuit 106 is a TRIAC-based (triode for alternating current based) regulation circuit. The frequency/power regulation circuit 106 is configured for adjusting the power of the heating device or the light-emitting device serving as the execution unit 101 according to control instructions issued by the processor 102, thereby achieving temperature increase or brightness adjustment control.

### The fourth embodiment:

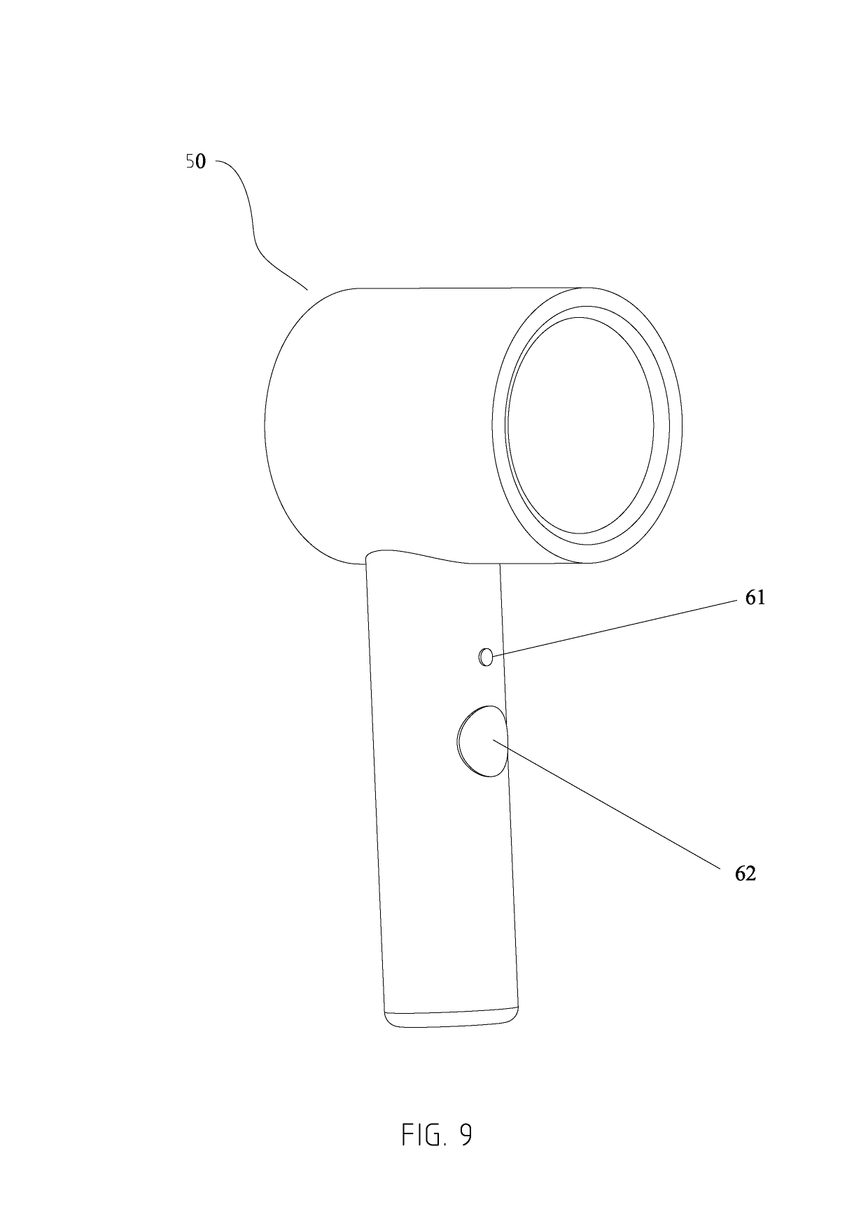

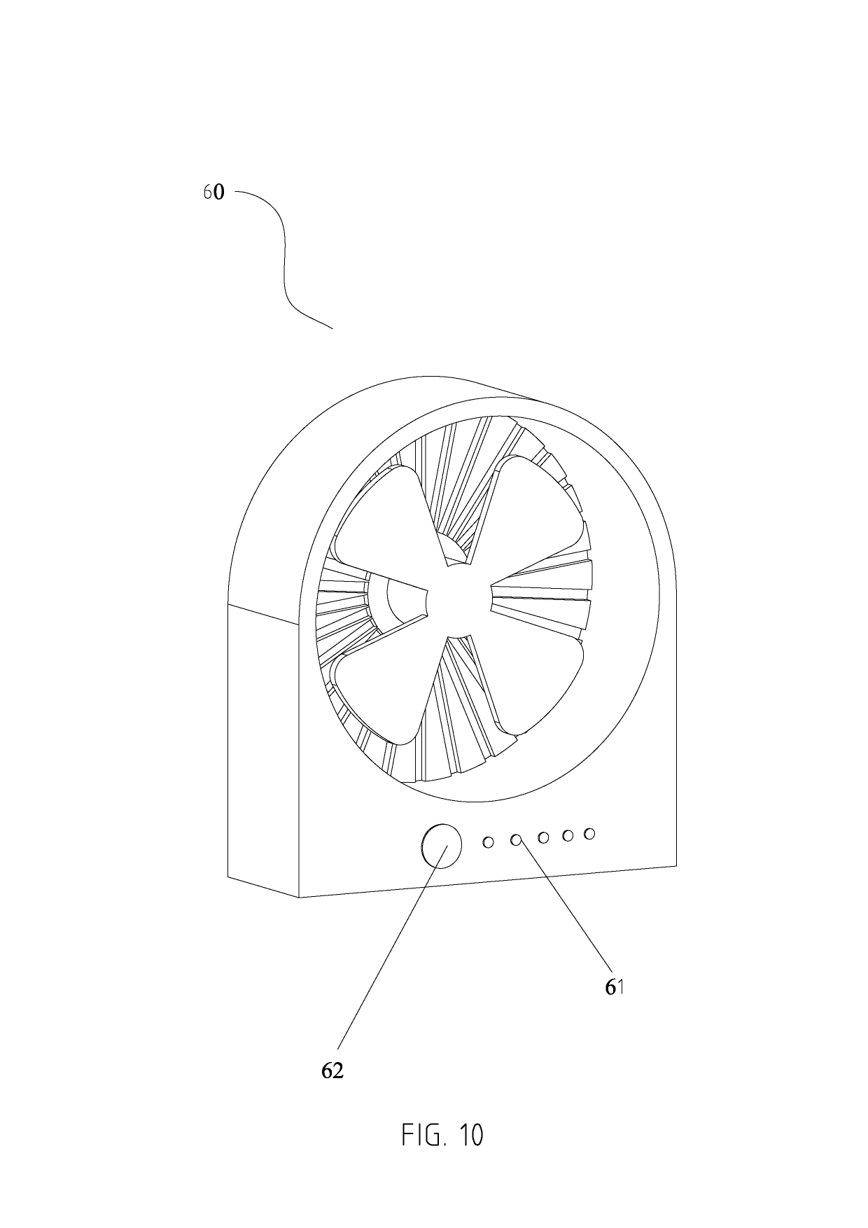

The remote-controlled electronic device of the present disclosure may also be an air-blowing device 60. As shown in FIG. 9 - FIG. 10, the air blowing device is a hair dryer 60 or a fan 70. Correspondingly, the execution unit 101 may be a blower, and the frequency/power regulation circuit 106 is a TRIAC-based (triode for alternating current based) regulation circuit. The frequency/power regulation circuit 106 is configured for adjusting the power of the execution unit 101 according to control instructions issued by the processor 102, thereby achieving regulation and control of the wind speed.

Preferably, both the hair dryer 60 and the fan 70 are provided with at least one fourth indicator light 61 and at least one fourth control button 62. Both the fourth indicator light 61 and the fourth control button 62 are electrically connected to the processor 102. The fourth indicator light 61 is used to indicate a state of the hair-blowing device. The fourth control button 62 is used to control the operating state of the hair-blowing device.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

1. A remote-controlled electronic device, comprising:
an electronic device terminal, the electronic device terminal comprising an execution unit, a processor, and a wireless signal receiving module, and the execution unit and the wireless signal receiving module being connected to the processor;
a remote control unit, wherein the remote control unit comprises a pressure sensor and a wireless signal transmitting module, and the pressure sensor is connected to the wireless signal transmitting module;
the wireless signal transmitting module is in signal communication with the wireless signal receiving module, and the wireless signal transmitting module is configured for transmitting pressure information detected in real time by the pressure sensor to the wireless signal receiving module, so as to adjust a real-time operating frequency or power of the execution unit.

2. The remote-controlled electronic device according to claim 1, wherein the remote control unit further comprises a switching device, the switching device is configured for issuing a start or a stop command signal and transmitting the command signal to the wireless signal receiving module, so as to control startup and shutdown of the execution unit.

3. The remote-controlled electronic device according to claim 2, wherein the remote control unit comprises a housing, the switching device, the pressure sensor, and the wireless signal transmitting module are arranged inside the housing, and the housing is at least provided with a deformable elastic portion positioned opposite the pressure sensor, so as to trigger the pressure sensor upon deformation.

4. The remote-controlled electronic device according to claim 3, wherein the housing is made of silicone.

5. The remote-controlled electronic device according to claim 1, wherein the electronic device terminal comprises a first circuit board, the processor and the wireless signal receiving module are integrated on the first circuit board, and the execution unit is connected to the first circuit board.

6. The remote-controlled electronic device according to claim 1, wherein the remote control unit comprises a second circuit board, and a switching device, the pressure sensor, and the wireless signal transmitting module are integrated on the second circuit board.

7. The remote-controlled electronic device according to claim 5, wherein an execution unit control circuit and a frequency/power regulation circuit are integrated on the first circuit board, and the execution unit control circuit comprises the processor and a drive circuit.

8. The remote-controlled electronic device according to claim 7, wherein the execution unit is a motor.

9. The remote-controlled electronic device according to claim 8, wherein the motor is a variable frequency motor.

10. The remote-controlled electronic device according to claim 9, wherein the frequency/power regulation circuit is a pulse width modulation circuit, and the frequency/power regulation circuit is configured for adjusting the frequency of the motor serving as an execution unit based on control instructions issued by the processor, so as to achieve acceleration of the electronic device terminal.

11. The remote-controlled electronic device according to claim 10, wherein the electronic device terminal is a toy device, and the motor is configured for driving the toy device to move.

12. The remote-controlled electronic device according to claim 11, wherein the toy device is a toy vehicle, an interactive toy, or an adult toy.

13. The remote-controlled electronic device according to claim 10, wherein the electronic device terminal is a massage device, and the motor is configured for driving a massage portion of the massage device to perform a massage action.

14. The remote-controlled electronic device according to claim 13, wherein the massage device is a neck massage device, a facial massage device, a waist massage device, or an eye massage device.

15. The remote-controlled electronic device according to claim 10, wherein the electronic device terminal is an air-blowing device, and the motor is configured for driving the air-blowing device to operate.

16. The remote-controlled electronic device according to claim 15, wherein the air-blowing device is a hair dryer or a fan.

17. The remote-controlled electronic device according to claim 7, wherein the execution unit is a heating device.

18. The remote-controlled electronic device according to claim 17, wherein the frequency/power regulation circuit is a triode for alternating current based bidirectional thyristor TRIAC-based regulation circuit, the frequency/power regulation circuit is configured for adjusting the power of the heating device serving as an execution unit based on control instructions issued by the processor, so as to achieve temperature increase in the electronic device terminal.

19. The remote-controlled electronic device according to claim 7, wherein the execution unit is a light-emitting device.

20. The remote-controlled electronic device according to claim 19, wherein the frequency/power regulation circuit is a triode for alternating current based bidirectional thyristor TRIAC-based regulation circuit, and the frequency/power regulation circuit is configured for adjusting the power of the light-emitting device serving as an execution unit based on control instructions issued by the processor, so as to achieve brightness adjustment of the electronic device terminal.
